(19) United States
(12) Patent Application Publication
(10) Pub. No.: US 2015/0170063 A1
(43) Pub. Date: Jun. 18, 2015

(54) Pattern Based Transit Routing

(71) Applicant: Google Inc., (US)

(72) Inventors: Albert Graells, Zurich (CH); Lucien Pech, Zurich (CH)

(73) Assignee: Google Inc., Mountain View, CA (US)

(21) Appl. No.: 13/893,961

(22) Filed: May 14, 2013

(51) Int. Cl. G06Q 10/02

(52) U.S. Cl. CPC G06Q 10/025

(57) ABSTRACT

Systems and methods for pattern based transit routing are provided. One exemplary method includes determining a plurality of trip patterns between an origin and a destination responsive to a user request. Trips for each of the plurality of trip patterns are generated, each trip corresponding to an instance of transportation. The trips are filtered. Each trip in the filtered trips is annotated with transit data. Responsive to a user request, one or more trips are selected from the annotated trips based upon the transit data associated with each respective trip, the user request, or combinations thereof.

### FIELD

The present disclosure relates generally to transit system trip planning and more particularly to pattern based transit routing.

### BACKGROUND

Many services exist for planning a route using a transit system. Typically, a user inputs a departure and/or arrival time as well as origin and destination locations to the transit planning service. Search algorithms are used to identify possible transit trips between the origin and the destination across one or more modes of transportation, such as ferries, buses, rails, walking, etc. Given the multiple modes of transportation available between the origin and destination, these search algorithms can return a very large set of possible transit trips between the origin and destination.

Not all transit trips in the set of possible transit trips found using search algorithms are suitable for recommending to a user. A way of selecting a subset of transit trips is to identify a subset of transit trips that optimize a specified criteria, such as shortest duration, earliest arrive time, cheapest cost, least amount of walking, etc. The problem with this approach is that some results determined in this manner would not make sense for recommendation to a user. As an example, most people would not pay ten times more for a trip to reduce five minutes of walking.

Other approaches for comparing and selecting a reasonable subset of transit trips from a large initial set of transit trips involve scoring the transit trips using complex algorithm concepts to assess multiple criteria. These approaches require assumptions about several properties of the initial set of transit trips, such as Pareto-optimality. In addition, these approaches can require very complex algorithms that can be difficult and costly in terms of computing time and resources to implement.

For example, one way of selecting a transit trip is to perform a multi-criteria shortest path algorithm with respect to a cost model that incorporates time, penalties, cost, or other parameters. Such shortest path algorithm can be used to determine the optimal trip given the specific cost model. However, one problem associated with such strategy includes, as noted above, computational cost when performed in response to each user query.

More particularly, however, the use of a cost model to select the particular transit trip to recommend to a user has several drawbacks. For example, the cost model must accurately reflect the specific user's preferences, which is difficult given a diverse set of users and a single cost model. Therefore, the provided result can be optimal according to the cost model, but not with respect to the actual user. Further, because understanding why a given result was selected based on the cost model requires significant analysis of internal parameter weights and available paths, predicting results of or fine tuning the cost model can be extremely difficult and unstable. In addition, often only a single, optimal result is provided, when a user may desire to select from among several possible transit trips.

### SUMMARY

Aspects and advantages of the invention will be set forth in part in the following description, or may be obvious from the description, or may be learned through practice of the invention.

One exemplary aspect of the present disclosure is directed to a computer-implemented method of determining and identifying trips associated with transit trip patterns. The method includes determining a plurality of trip patterns between an origin and a destination responsive to a user request. Trips for each of the plurality of trip patterns are generated, each trip corresponding to an instance of transportation according to one of the plurality of trip patterns. The trips are filtered. Each trip in the filtered trips is annotated with transit data. One or more trips are selected from the annotated trips based upon the transit data associated with each respective trip, the user request, or combinations thereof.

Other exemplary aspects of the present disclosure are directed to systems, apparatus, non-transitory computer-readable media, computer program products, user interfaces and devices for transit planning

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts an overview of an exemplary system for transit trip planning according to an exemplary embodiment of the present disclosure;

FIG. 2 depicts a flowchart of an exemplary method for providing a transit trip in response to a user query according to an exemplary embodiment of the present disclosure;

FIG. 3 depicts a flow diagram of an exemplary method for selecting a subset of transit trips from a set of initial transit trips according to an exemplary embodiment of the present disclosure;

FIGS. 4 and 5 depict the exemplary generation of a trip duration function that specifies a minimum trip duration as a function of departure time according to an exemplary embodiment of the present disclosure;

FIG. 6 depicts an exemplary trip duration function that specifies a minimum trip duration as a function of arrival time according to an exemplary embodiment of the present disclosure;

FIG. 7 depicts an exemplary trip duration function for a set of transit trips that includes a frequency based transit trip according to an exemplary embodiment of the present disclosure;

FIG. 8 depicts the exemplary filtering of the set of transit trips based on the trip duration function according to an exemplary embodiment of the present disclosure; and

FIG. 9 depicts an exemplary computing system according to an exemplary embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to systems and methods for determining transit trip patterns, adding time to the trip patterns to generate transit trips, and filtering the transit trips associated with such trip patterns to identify a subset of reasonable transit trips. In certain aspects of the present disclosure, a large number of results can be generated responsive to a user query and the results can be filtered. In particular, rather than perform a single graph search in order to determine a single optimal transit trip for each user query, the process of determining transit trips can be implemented with different steps.

As an example, one exemplary method provided by the present subject matter includes, when a user enters a particular query, generating a large number of trip patterns describing a sequence of transfer stations or stops that connect the origin to the destination. Particular instances of travel across such sequences (“transit trips”) can then be identified. The transit trips can be filtered to provide the most relevant results for that particular user and query.

Trip patterns can be generated by any suitable method. Each trip pattern can describe a sequence of stations at which a traveler boards or alights a vehicle providing transportation, such as particular instances of transportation by bus lines, rail lines, etc. First, a transit graph comprising a plurality of arcs (available instances of transportation) and nodes (arrival or departure of an instance of transportation at a transit station) can be searched to find a first optimal trip pattern from the origin to the destination according to a given cost model. For example, a Dijkstra search and/or variants thereof such as a K shortest path routing algorithm can be utilized to identify trip patterns. It should be understood that other algorithms of similar functionality will be evident to those skilled in the art. In certain aspects of the present disclosure, a precomputed set of results can be utilized. Such results can also be utilized in combination with those generated using graph search methods.

Next, time is added to the trip patterns to generate transit trips. Using the departure time T specified for the user, and a sequence of stations (A→B→C→D), taken from a trip pattern, a trip that goes from A to B is selected, that doesn't depart before T and that reaches B as early as possible. The process is repeated for the remaining segments (i.e., for the connection B→C, C→D, or the like) but using as starting time, the arrival time at the start of the segment (i.e., for the segment B→C, the starting time would be the arrival time at B.

Transit trips can be filtered using any suitable method. For instance, in certain aspects of the present disclosure, a subset of reasonable transit trips can be further analyzed based on various criteria (e.g. earliest arrival, lowest price, least amount of walking, least number of transfers, fare, etc.) to recommend one or more transit trips to a user.

For example, in certain aspects a trip duration function can be generated based on trip data. The trip duration function can specify a minimum trip duration for the initial set of transit trips as a function of time, such as departure time or arrival time, over the time interval. For example, the trip duration function can be a function f(t) that for each possible time “t” computes the trip duration associated with reaching the destination, including any possible waiting time. The function f(t) can be based on departure time or arrival time. For instance, for departure times, the function f(t) can specify for each possible departure time “t” the duration to reach the destination (i.e. a user departing at time “t” will arrive at the destination at time t+f(t)). For arrival times, the function f(t) can specify for each possible arrival time “t,” the duration before “t” the user should have left to reach the destination (i.e. a user desiring to arrive at time “t” should depart at time t−f(t)).

The trip duration function can be a piecewise linear function with one or more linear trip segments. Each linear trip segment can model the duration, including waiting time, of one of the initial set of transit trips over at least a portion of the time interval. In particular implementations, one or more penalties can be added to the trip duration for each possible time “t” to take into account factors such as walking, transfers, pricing, preferred modes of transportation, etc. The penalties can be quantified as a unit of time. For instance, a transfer can be associated with a penalty of five minutes of travel.

The trip duration function can be used to filter trips from the initial set of transit trips to identify the subset of reasonable transit trips based on trip duration relative to the minimum trip duration specified by the trip duration function. In particular, each transit trip can be analyzed to determine whether the transit trip contributes to a minimum or optimal trip duration specified by the trip duration function. Transit trips that do not provide a trip duration within a threshold of the minimum trip duration specified by the trip duration function can be removed from the initial set of transit trips.

The trip duration function can be used to filter transit trips based on departure time or based on arrival time. For instance, a trip duration function specifying a minimum trip duration as a function of departure time can be used to identify a subset of reasonable trips responsive to departure time based requests. A trip duration function specifying a minimum trip duration as a function of arrival time can be used to identify a subset of reasonable trips responsive to arrival time based requests. Alternatively, filtering can be applied based on both departure time and arrival time. For instance, a first trip duration function can be used to filter trips based on departure time and a second trip duration function can be used to filter trips based on arrival time.

In addition, transit trips can be annotated with information like total fare, wheelchair accessibility, or can be dynamically enhanced with real-time information. Transit trips can then be selected for recommendation to a user with optimization based one or more factors, such as pricing, number of transfers, shortest duration, earliest arrival, departure time, required walking, and other factors, including information previously described as being annotated to such trips.

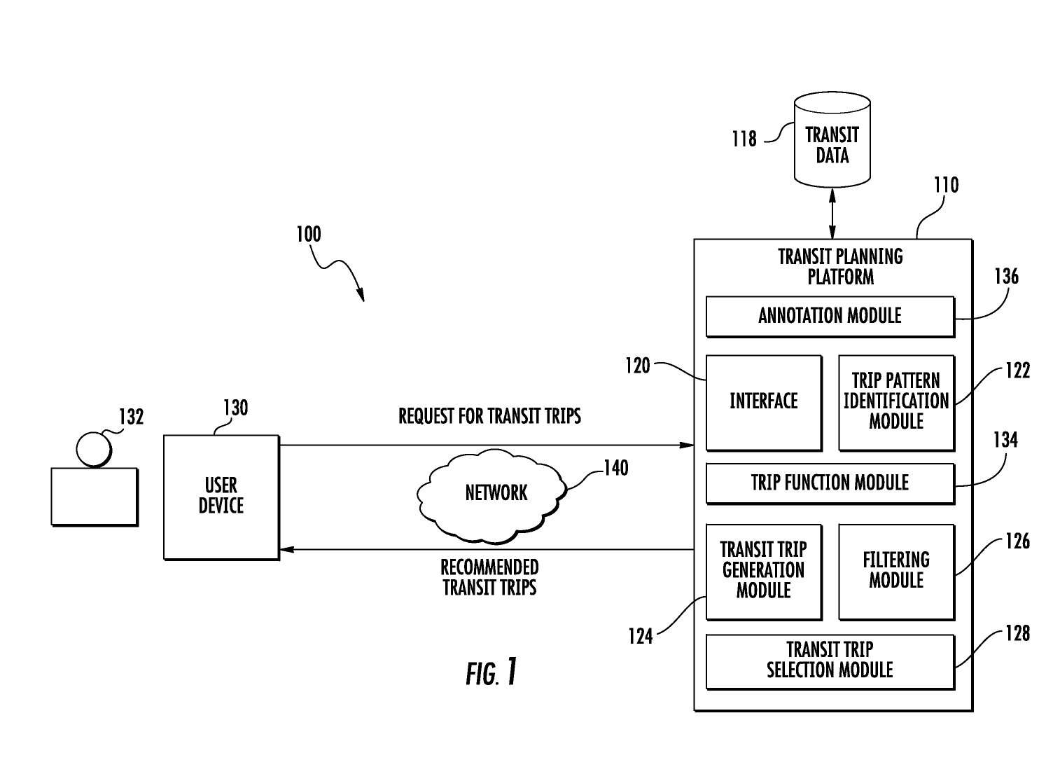

With reference now to the FIGS., exemplary embodiments of the present disclosure will now be discussed in detail. FIG. 1 depicts an overview of an exemplary system 100 for transit trip planning according to an exemplary embodiment of the present disclosure. The system 100 can include a transit planning platform 110 in communication with a computing device 130 over a network 140. The transit planning platform 110 can be hosted by any suitable computing device, such as a web server. The computing device 130 can be any suitable computing device, such as a laptop, desktop, smartphone, tablet, mobile device, wearable computing device, or other computing device.

A user 132 can input a request for one or more transit trips from an origin to a destination into the computing device 130 using a suitable user interface, such as a browser or other interface, including an interface embedded into a geographic information system. The computing device 130 can send the request for transit information to the transit planning platform 110. The request can be for a recommendation of specific transit trips between an origin and destination. The transit trips can be associated with one or more different transit routes and can use one or more modes of transportation, such as rails, ferries, buses, etc.

As used herein, a transit route is a fixed set of transit paths between an origin and a destination and can include multiple modes of transportation. An example transit route can be a combination of one or more portions of transit lines, such as bus lines, rail lines, walking paths, etc. that allow an individual to reach the destination. A transit trip is a specific instance of transportation over the transit route and is associated with a particular departure time and a particular arrival time. A plurality of transit trips can be associated with each transit route and can have different departure and arrival times.

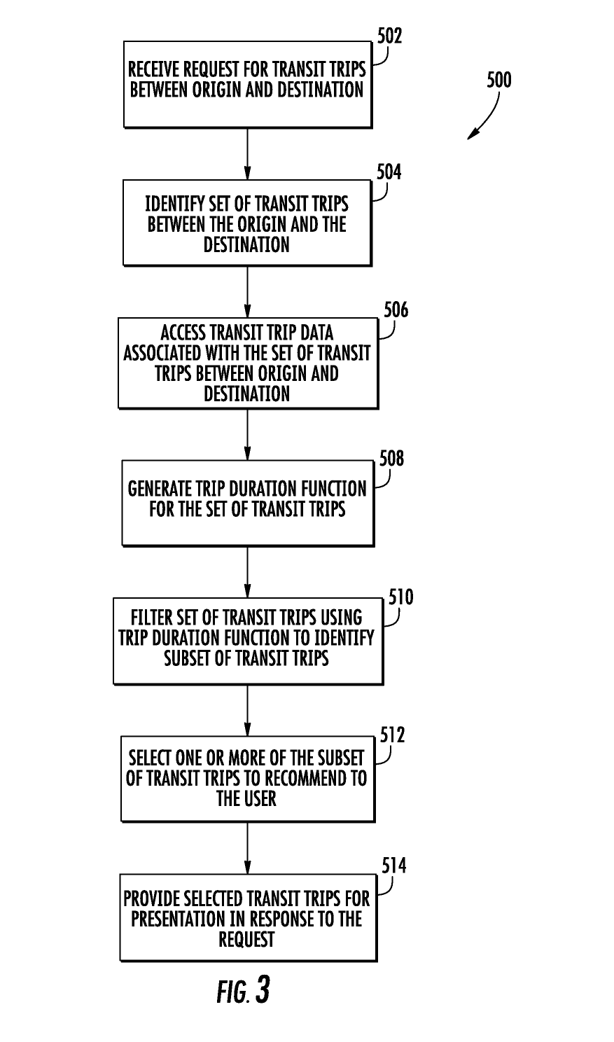

A transit trip exhibits a trip pattern. In particular, the sequence of stations at which a traveler traveling upon such transit trip boards or alights a vehicle providing transportation can be described by a trip pattern. As such, the trip pattern for each transit trip can describe, in order, each instance in which a traveler travelling upon such transit route would board, get on, get off, disembark, or alight vehicles, transit lines, or modes of transportation. Transit trips and trip patterns will be discussed further with respect to FIG. 3.

Returning to FIG. 1, the request for transit trips can be a departure time based request or an arrival time based request. A departure time based request seeks transit trips between an origin and a destination that depart later than a specified time T_{D}. Usually, transit trips are optimized for arrival time in recommending transit trips responsive to the departure time based request. An arrival time based request seeks transit trips between an origin and a destination that arrive earlier than a specified time T_{A}. Transit trips are typically optimized for departure time in recommending transit trips responsive to the arrival time based request.

The transit planning platform 110 can receive the request from the computing device 130. For example, the transit planning platform 110 can include a suitable interface 120 for connecting to the network 140 and receiving the request. The transit planning platform 110 can access transit data 118. Transit data 118 can include information associated with one or more transit systems, such as transit schedules, departure times, arrival times, stops, fares, walking distance, transfers, and other information associated with the one or more transit systems. Transit data 118 can be stored in one or more internal or external databases or other suitable storage means or can be accessed via network 140.

Responsive to a user request, the transit planning platform 110 can implement a trip pattern identification module 122 to identify a plurality of trip patterns respectively associated with a plurality of transit trips between an origin and a destination. Each trip pattern can describe a sequence of stations or stops at which a passenger upon a transit trip either boards or disembarks a vehicle providing transportation.

The transit planning platform 110 can also implement a transit trip generation module 124 to generate a set of transit trips. In particular, transit trip generation module 124 can generate or identify one or more transit trips for each of the plurality of trip patterns identified by trip pattern identification module 122. In some instances, transit trip generation module 124 can be viewed as “adding time” to the trip patterns determined by trip pattern identification module 122.

For instance, known data structures can be utilized to efficiently associate to the previously determined trip patterns. For instance, a data structure that returns all optimal costs of direct connections can be utilized.

The transit planning platform 110 can implement a filtering module 126 to filter the set of transit trips to identify a subset of reasonable transit trips between the origin and the destination. For example, filtering module 126 can delete transit trips generated by transit trip generation module 124 that do not meet basic criteria, such as, for example, transit trips that exceed a threshold duration. In certain aspects of the present disclosure, transit trips can be filtered based on earliest arrival, lowest price, least amount of walking, least number of transfers, fare or the like. In certain aspects of the present disclosure, one or more functions can be generated that describe a minimum duration for a given set of transit trips and the set of transit trips can be filtered based on such functions. The transit planning platform 110 can implement a trip function module 134 to generate one or more trip duration functions for the set of transit trips. Filtering module 126 can filter out transit trips from the set that do not provide an optimal trip duration at some specific time over a time interval.

A transit trip selection module 128 can then be used to select one or more of the subset of filtered transit trips to recommend to the user 132 in response to the request based on optimization of one or more factors, such as arrival time, departure time, duration, least walking, reduced prices, preferred routes or transportation providers, etc. In addition, transit trip selection module 128 can take into account annotations that have been previously added to the transit trips by annotation module 136, including, for example, information regarding wheelchair accessibility. Transit trip selection module 128 can select a plurality of transit trips for recommendation such that a user is provided with the opportunity to select among trips exhibiting diversity of vehicles, patterns, or transportation providers. In such fashion, user 132 can select the transit trip that best suits their preferences.

After the trip selection module 128 selects one or more transit trips for responding to the request, the transit planning platform 110 can send the transit trips to the user device 130, for instance, over the network 140. The user device 130 can then display the one or more time transit trips to the user 132 through a suitable user interface. In particular, in some implementations, user device 130 can provide the recommended transit trips in conjunction with a geographic information system or device location identification system in order to provide user 132 with continuing navigational instructions.

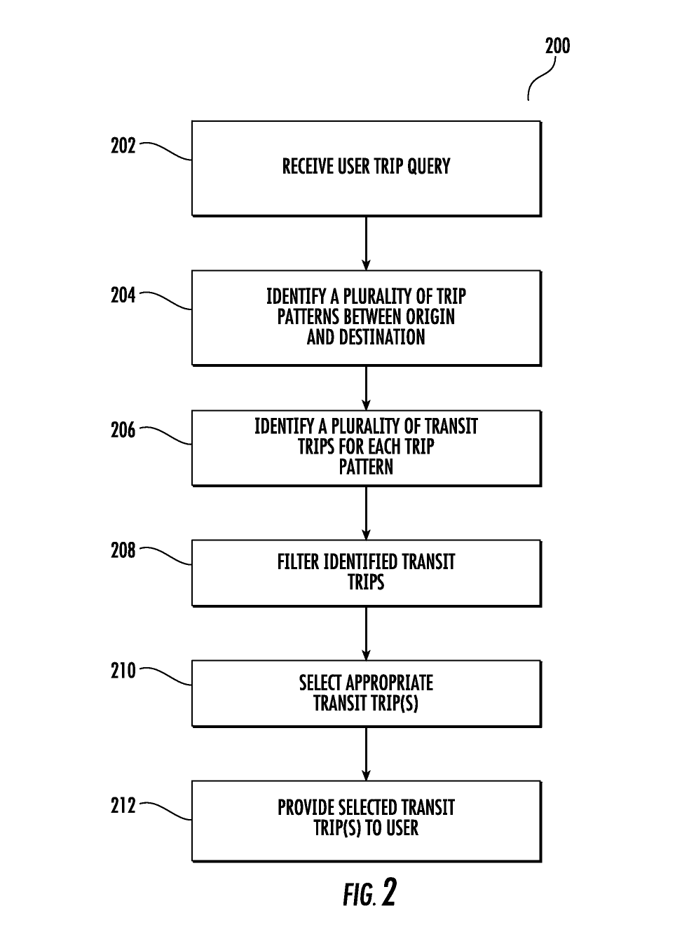

FIG. 2 depicts a flow diagram of an exemplary method (200) for providing a transit trip in response to a user query according to an exemplary embodiment of the present disclosure. While exemplary method (200) will be discussed with reference to the system 100 of FIG. 1, method (200) can be implemented using any suitable computing system. In addition, although FIG. 2 depicts steps performed in a particular order for purposes of illustration and discussion, methods of the present disclosure are not limited to such particular order or arrangement. One skilled in the art, using the disclosures provided herein, will appreciate that various steps of the method (200) can be omitted, rearranged, combined, and/or adapted in various ways without deviating from the scope of the present disclosure.

At (202) a user trip query can be received. As an example, user 132 can enter a request for transit trips into user device 130. The request for transit trips can be communicated by user device 130 to transit planning platform 110 over network 140. The request for transit trips can include one or more parameters, such as an origin, a destination, an arrival time, a departure time, preferred vehicle types, preferred vehicle providers, or other suitable parameters.

At (204) a plurality of trip patterns between an origin and a destination can be identified. As an example, transit panning platform 110 can implement trip pattern identification module 122 to identify a plurality of trip patterns.

Each transit trip can exhibit a trip pattern. In particular, the trip pattern for a transit trip can describe a sequence of transfer stations or stops traversed by such transit trip or visited by a passenger travelling upon such transit trip. For example, the trip pattern for a transit trip can describe, in sequence, each instance in which a passenger travelling upon such transit trip is required to change or transfer vehicles, transit lines, or modes of transportation.

Additional trip patterns can be identified by performing one or more graph traversal algorithms with respect to the second transit graph. All identified trip patterns can be stored for further processing.

At (206) a plurality of transit trips can be identified for each time-independent trip pattern. As an example, transit planning platform 110 can implement transit trip generation module 124 to generate the plurality of transit trips based on the plurality trip patterns identified at (202). In some instances, (206) can be viewed as “adding time” to the plurality of trip patterns.

At (208) the plurality of transit trips identified at (206) can be filtered. FIG. 5 depicts an exemplary method for filtering. As an example, transit planning platform 110 can implement filtering module 126 to filter the plurality of transit trips. For example, transit trips which do not meet certain criteria can be discarded. As another example, one or more functions can be generated that describe a minimum duration for a given set of transit trips and the set of transit trips can be filtered based on such functions. For instance, transit trips that do not provide an optimal trip duration at some specific time over a time interval can be filtered out or discarded. In addition, transit trips can be annotated with information like total fare, wheelchair accessibility, or can be dynamically enhanced with real-time information. Such real time information can be used to modify the duration of a trip.

At (210) appropriate transit trips can be selected. As an example, transit planning platform 110 can implement transit trip selection module 128 to select from the set of transit trips that were filtered at (206). For example, transit trips can be selected based on optimization of one or more factors, such as arrival time, departure time, duration, least walking, reduced prices, preferred routes, or vehicle providers, etc.

At (212) the selected transit trips can be provided to the user. As an example, transit planning platform 110 can provide recommended transit trips to user 132 via user device 130 over network 140.

After (212), method (200) can return to (202) and receive additional user trip queries.

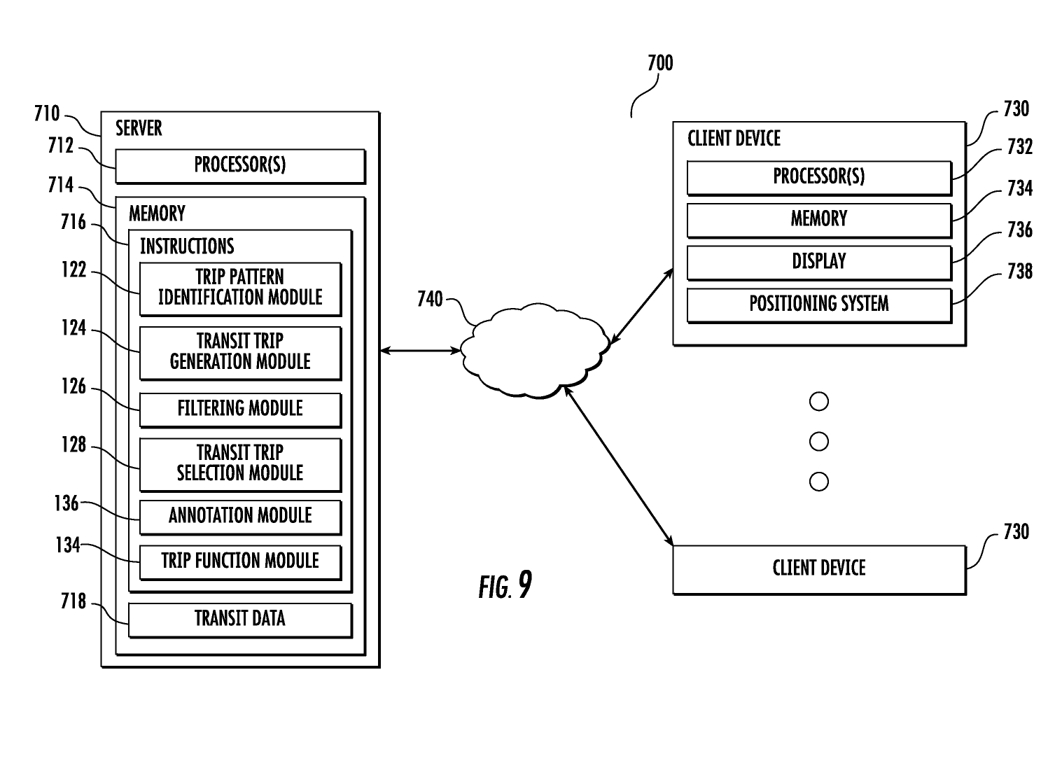

FIG. 3 depicts a flow diagram of an exemplary method (500) for identifying a subset of reasonable transit trips from an initial set of transit trips according to an exemplary embodiment of the present disclosure. The method (500) can be implemented using any suitable computing device or system, such as the system 700 depicted in FIG. 9. In addition, FIG. 3 depicts steps performed in a particular order for purposes of illustration and discussion. Those of ordinary skill in the art, using the disclosures provided herein, will understand that the various steps of any of the methods disclosed herein can be omitted, adapted, and/or rearranged in various ways.

At (502), the method includes receiving a request for transit trips between an origin and a destination. For instance, the transit planning platform 110 of FIG. 1 can receive a request for transit trips from a user device 130 over a network 140. The request can be a departure time based request or an arrival time based request. In addition, the request can ask for optimal transit trips based on one or more other factors, such as lowest fare, least amount of walking, shortest duration, least number of transfers, etc. The request can also be a request for typical transit routes from the origin to the destination irrespective of a specific time of day and/or date. Other suitable requests for transit information can be provided without deviating from the scope of the present disclosure.

At (504) of FIG. 3, the method includes identifying transit trips over a time interval between the origin and destination specified in the request as described herein.

To identify a subset of reasonable transit trips, transit trip data associated with each of the transit trips in the set of transit trips is accessed (506). For instance, transit trip data can be accessed from the transit data 118 of FIG. 1. The transit trip data can include information necessary to identify the duration of one or more of the transit trips in the set of transit trips. For instance, the transit trip data can include the departure time, arrival time, and/or the duration of the transit trips. The departure time and the arrival time can be estimated time(s) or can be times determined or identified from data associated with the transit network, such as transit time tables. In certain embodiments, the duration of the transit trip can be determined from the arrival time and the departure time, for instance, by computing the difference between the arrival time and the departure time.

At (508), a trip duration function is generated for the initial set of transit trips. For example, the trip function module 134 of FIG. 1 can generate a trip duration function for the set of transit trips. The trip duration function specifies a minimum trip duration for the set of transit trips as a function of time (e.g. departure time or arrival time) for the time interval. For instance, the trip duration function can be a function f(t) that specifies a minimum trip duration to reach the destination for every time t. The trip duration can incorporate penalties into the minimum duration for factors such as walking, required transfers, fares, etc. As will be discussed in more detail below, the trip duration function can be a piecewise linear function that includes a plurality of linear trip segments.

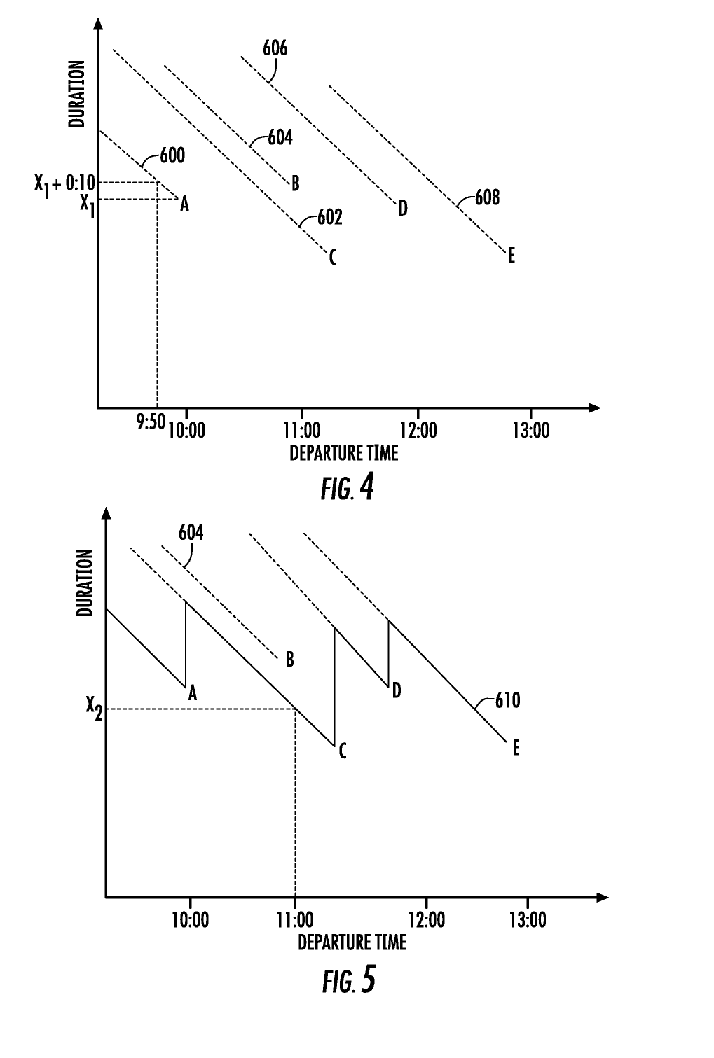

FIGS. 4 and 5 depict the exemplary generation of a trip duration function that specifies a minimum trip duration based on departure time for a set of transit trips according to an exemplary embodiment of the present disclosure. In particular, the trip duration function can be constructed by generating a linear trip segment for each transit trip in the set of transit trips. For instance, linear trip segments 600, 602, 604, 606, and 608 can be generated for transit trips A, B, C, D, and E respectively. The present example will be discussed with reference to five transit trips for purposes of illustration and discussion. Those of ordinary skill in the art, using the disclosures provided herein, will understand that the trip duration function can include any number of transit trips.

Each linear trip segment models a trip duration, including waiting time, of one of the transit trips in the set of transit trips as a function of time. The linear trip segment can be determined for a transit trip by identifying the duration and a departure time for the trip. The duration can simply be the trip duration and/or can also include penalties for factors such as walking, required transfers, pricing, etc. The linear trip segment specifies the duration of the trip at the departure time for the trip and has a slope of −1 to model waiting time. For example, trip A begins at 10:00 and has a duration of x1. The trip segment 300 associated with trip A has a slope of −1 to model waiting time. For instance, if a user begins travel at time 9:50, the user will have to wait 10 minutes until the transit trip A associated with trip segment 600 departs. Thus, the trip segment 600 specifies a trip duration of x₁+0:10 at time 9:50. The trip segments 602, 604, 606, and 608 can be modeled in a similar fashion.

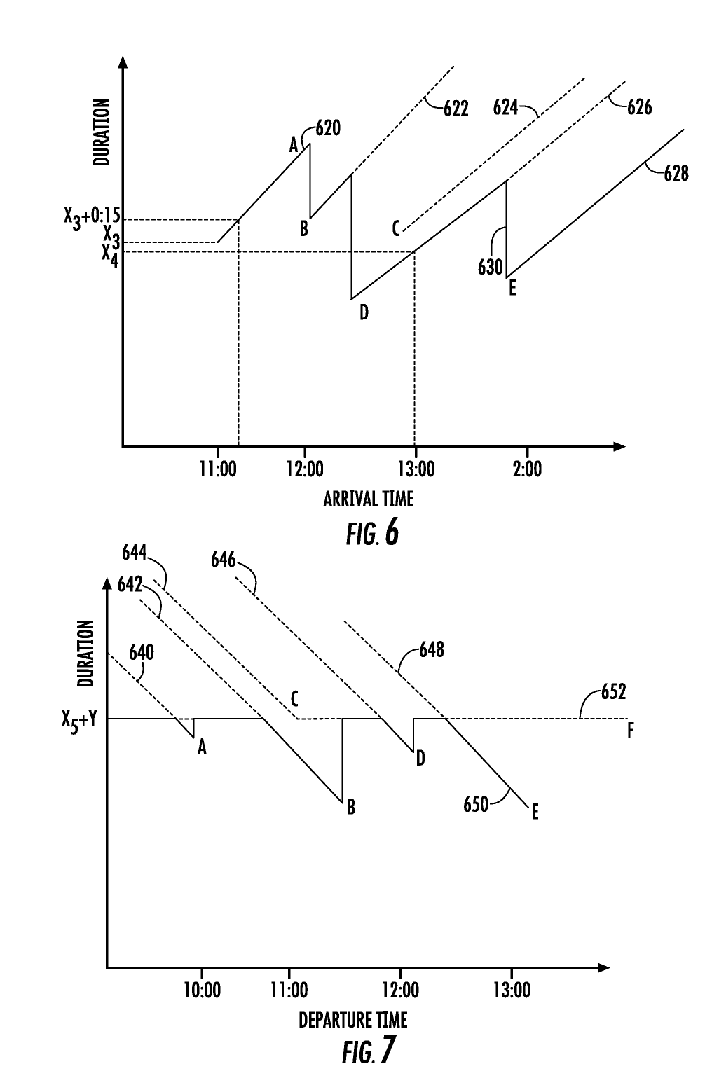

As shown in FIG. 6, a trip duration function 610 is generated from the linear trip segments by identifying the minimum trip duration of each of the trip segments at each possible departure time. In particular, the trip duration function 610 specifies the minimum trip duration to reach the destination for each departure time. The minimum duration to arrive at the origin using the set of transit trips at a particular departure time can be determined by evaluating the trip duration function 610 at the particular departure time. For instance, the trip duration function 610 specifies a minimum trip duration of x2 for a departure time of 11:00 to arrive the destination using the set of transit trips A, B, C, D, and E.

A trip duration function can also be generated based on arrival time. In particular, the trip duration function can specify a minimum trip duration as a function of each possible arrival time with in a time interval. FIG. 6 depicts an exemplary trip duration function 630 that specifies a minimum trip duration based on arrival time for a set of transit trips according to an exemplary embodiment of the present disclosure. The trip duration function 630 can be constructed by generating a linear trip segment for each transit trip in the set of transit trips. For instance, linear trip segments 620, 622, 624, 626, and 628 can be generated for transit trips A, B, C, D, and E respectively.

Each linear trip segment models a trip duration, including waiting time, of one of the transit trips in the set of transit trips as a function of arrival time. The linear trip segment can be determined for a transit trip by identifying the duration and an arrival time for the trip. The duration can simply be the trip duration and/or can also include penalties for factors such as walking, required transfers, fares, etc. The linear trip segment specifies the duration of the trip at the arrival time for the trip and has a slope of 1 to model waiting time. For example, trip A arrives at 11:00 and has a duration of x3. The trip segment 620 associated with trip A has a slope of 1 to model waiting time. For instance, if a user desires to arrive at 11:15, the user will have to wait 15 minutes after transit trip A arrives to arrive at the desired time. Thus, the trip segment 620 specifies a trip duration of x₃+0:15 at time 11:15. The trip segments 622, 624, 626, and 628 can be modeled in a similar fashion.

As shown in FIG. 6, a trip duration function 630 is generated from the linear trip segments by identifying the minimum trip duration of each of the trip segments at each possible arrival time. In particular, the trip duration function 630 specifies the minimum trip duration to reach the destination for each arrival time. The minimum duration to arrive at the origin using the set of transit trips at a particular departure time can be determined by evaluating the trip duration function 630 at the particular departure time. For instance, the trip duration function 630 specifies a minimum trip duration of x4 for an arrival time of 13:00 using the set of transit trips A, B, C, D, and E.

In some cases, the set of transit trips can include a frequency based transit trip. The exact departure and arrival times for the frequency based transit trip may be unknown. However, it may be known that over a given time interval, a particular transit trip runs every Y minutes and has a duration of x5. Based on this information, it is known that the frequency based trip will have a maximum duration of x5+Y including waiting time. A linear trip segment can be generated to model the frequency based trip as a linear segment having a slope of zero that specifies a duration equal to x5+Y.

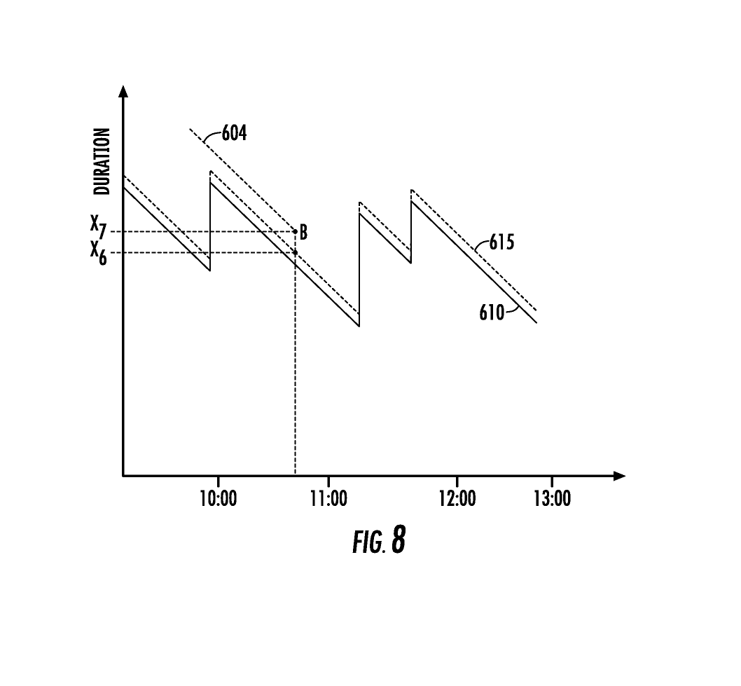

For example, FIG. 7 depicts a trip duration function 650 for a set of transit trips that includes a frequency based trip. The trip duration function 650 specifies a minimum trip duration as a function of departure time. The trip duration function 650 can be constructed by generating linear trip segments 640, 642, 644, 646, and 648 having a slope of −1 to model the duration, including waiting time, of trips A, B, C, D, and E respectively. The set can include an additional frequency based trip F. The frequency based transit trip F can have a duration of x5 and can run every Y minutes. A linear trip segment 652 having a slope of 0 and a value equal to x5+Y can be used to model the frequency based transit trip F. The trip duration function 650 can be constructed by identifying the minimum trip duration specified by the linear trip segments 640, 642, 644, 646, 648 and 652.

Referring back to FIG. 3 at (510), the method includes filtering the set of transit trips using the trip duration function to identify the subset of transit trips. For instance, the filtering module 126 can filter the set of transit trips using the trip duration function. More particularly, the set of transit trips is filtered based on trip duration relative to the minimum trip duration specified by the trip duration function. For instance, if a particular transit trip in the set of transit trips does not provide a trip duration within a threshold of the minimum trip duration specified by the trip duration function at any time within the time interval, the particular transit trip can be removed from the set.

For instance, referring to FIG. 5, transit trip B does not contribute to the trip duration function 610. More specifically, the linear trip segment 604 does not provide a trip duration that contributes to the minimum trip duration specified by the trip duration function. As a result, transit trip B can be removed from the initial set of transit trips to identify a subset of reasonable transit trips.

FIG. 8 depicts one exemplary process for filtering the set of transit trips based on a trip duration function 610 for the set of transit trips depicted in FIG. 5. A threshold function 615 can be generated based on the trip duration function 610. The threshold function 615 can be equal to the trip duration function plus some threshold Z. For instance, the threshold function can be specified as follows:

g(t)=f(t)+Z

where g(t) is the threshold function, f(t) is the trip duration function, and Z is the threshold. The threshold Z can be set to any desired value such as 10 minutes. In some cases the threshold Z can be set to zero such that the threshold function is equal to the trip duration function. The threshold Z can also be a function of f(t). For instance, Z could be 10% or other suitable percentage of f(t). In this example, g(t)=f(t)+0.1*f(t). This would allow for filtering of all trips that are worse than 10% of f(t).

Once the threshold function is generated, the threshold function can be used to filter one or more transit trips in the set of transit trips. For instance, the threshold function can be evaluated at a time (e.g. a departure time or arrival time) associated with one of the transit trips to determine a threshold trip duration. For instance, in FIG. 8, the threshold function 615 can be evaluated at the departure time 11:00 associated with the transit trip B to obtain a threshold trip duration of x6. A trip duration associated with the transit trip at the same time can then be obtained. For instance, the linear trip segment 604 associated with transit trip B can be evaluated at the departure time 11:00 to obtain a trip duration of x7. The transit trip can be removed from the set of transit trips if the trip duration at the departure time of the trip exceeds the threshold trip duration. In the example of FIG. 8, the trip duration x7 associated with trip B exceeds the threshold trip duration x6. As a result, transit trip B is removed from the set of transit trips.

The filtering techniques can be applied using a trip duration function generated based on departure time or a trip duration function generated based on arrival time. In one particular implementation, the filtering techniques can be applied using both arrival time and departure time. For instance, a first trip duration function can be generated for a set of transit trips specifying a minimum trip duration for the set of transit trips as a function of departure time. A second trip duration function can be generated for the set of transit trips specifying a minimum trip duration for the set of transit trips as a function of arrival time. The set of transit trips can be filtered based on trip duration relative to the minimum trip duration specified by the first trip duration function and the minimum trip duration specified by the second trip duration function. Filtering based on both arrival time and departure time can provide useful results. For instance, the departure time filtering filters transit trips that arrive much later than optimal. The arrival time filtering filters transit trips that depart much earlier than optimal.

As an example, consider a request for transit trips specifying a departure time of 1 am. An ideal transit trip for recommending in response to the request would be to wait until the morning to take a direct tram (e.g. Tram 3) that arrives at 6:10 a.m. However, another transit trip identified in response to the request can include a transit trip that takes the latest tram (e.g. Tram 4) of the day and then requires waiting until 6 am for the first tram (e.g. Tram 5) in the morning and taking the tram to arrive at 6:11 a.m. No reasonable user would opt for the latter transit trip. Filtering based only on departure time may not remove the latter transit trip from the set of transit trips because its arrival time is not much worse than optimal. However, the latter trip time would be filtered out using arrival time filtering. As a result, double filtering based on both departure time and arrival time can remove this kind of overnight trip.

Referring back to FIG. 3 at (512), once the subset of reasonable transit trips has been identified, the method can include selecting one or more of the subset of reasonable transit trips for recommendation to a user. For instance, the transit trip selection module 128 of FIG. 1 can select one or more of the subset of reasonable transit trips for recommendation to a user. The transit trips can be selected using any suitable criteria. For instance, the subset of reasonable transit trips can be analyzed based on several factors, such as duration, departure time, arrival time, fares, number of transfers, required walking, etc., to determine one or more optimal transit trips to recommend to the user.

At (512) of FIG. 3, the selected transit trips are provided for recommendation to the user in response to the request. For instance, the transit planning platform 110 of FIG. 1 can deliver the selected transit trips to the user device 130 over the network 140. The user 132 can then use the recommended transit trips in planning a transit journey.

FIG. 9 depicts an exemplary computing system 700 that can be used to implement the methods and systems for transit trip planning according to aspects of the present disclosure. The system 700 has a client-server architecture that includes a server 710 that communicates with one or more client devices 730 over a network 740. The system 700 can be implemented using other suitable architectures, such as a single computing device.

The system 700 includes a server 710, such as a web server. The server can host a transit planning platform. The server 710 can be implemented using any suitable computing device(s). The server 710 can have a processor(s) 712 and a memory 714. The server 710 can also include a network interface used to communicate with one or more remote computing devices (e.g. client devices) 730 over the network 740.

The processor(s) 712 can be any suitable processing device, such as a microprocessor, microcontroller, integrated circuit, or other suitable processing device. The memory 714 can include any suitable computer-readable medium or media, including, but not limited to, non-transitory computer-readable media, RAM, ROM, hard drives, flash drives, or other memory devices. The memory 714 can store information accessible by processor(s) 712, including instructions 716 that can be executed by processor(s) 712. The instructions 516 can be any set of instructions that when executed by the processor(s) 712, cause the processor(s) 712 to provide desired functionality. For instance, the instructions 716 can be executed by the processor(s) 712 to implement the trip pattern identification module 122, the transit trip generation module 124, the trip function module 134, the annotation module 136, the filtering module 126, and the transit trip selection module 128.

It will be appreciated that the term “module” refers to computer logic utilized to provide desired functionality. Thus, a module can be implemented in hardware, application specific circuits, firmware and/or software controlling a general purpose processor. In one embodiment, the modules are program code files stored on the storage device, loaded into memory and executed by a processor or can be provided from computer program products, for example computer executable instructions, that are stored in a tangible computer-readable storage medium such as RAM, ROM, hard disk or optical or magnetic media.

Memory 714 can also include data 718, such as transit data, that can be retrieved, manipulated, created, or stored by processor(s) 712. The data 718 can be stored in one or more databases. The one or more databases can be connected to the server 710 by a high bandwidth LAN or WAN, or can also be connected to server 710 through network 740. The one or more databases can be split up so that they are located in multiple locales.

The server 710 can exchange data with one or more client devices 730 over the network 740. Although two clients 730 are illustrated in FIG. 9, any number of client devices 730 can be connected to the server 710 over the network 740. The client devices 730 can be any suitable type of computing device, such as a general purpose computer, special purpose computer, laptop, desktop, integrated circuit, mobile device, smartphone, tablet, wearable computing device, or other suitable computing device.

Similar the computing device 710, a client device 730 can include a processor(s) 732 and a memory 734. The memory 734 can store information accessible by processor(s) 732, including instructions that can be executed by processor(s) 732 and data. The client device 730 can include various input/output devices for providing and receiving information from a user, such as a touch screen, touch pad, data entry keys, speakers, and/or a microphone suitable for voice recognition. For instance, the computing device 730 can have a display 736 for presenting information, such as recommended transit trips to a user.

The client device 730 can also include a positioning system 738 that can be used to identify the position of the client device 730. The positioning system 738 can be optionally used by the user to monitor the user's position relative to a transit route. The positioning system 738 can be any device or circuitry for monitoring the position of the client device 730. For example, the positioning device 738 can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or WiFi hotspots, and/or other suitable techniques for determining position.

In situations in which the systems and method discussed herein collect information about users, such as position data, user preferences, or other information, the users may be provided with an opportunity to control whether programs or features collect the information and control whether and/or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in or more ways before it is stored or used, so that personally identifiable information is removed.

The network 740 can be any type of communications network, such as a local area network (e.g. intranet), wide area network (e.g. Internet), or some combination thereof. The network 740 can also include a direct connection between a client device 730 and the server 710. In general, communication between the server 710 and a client device 730 can be carried via network interface using any type of wired and/or wireless connection, using a variety of communication protocols (e.g. TCP/IP, HTTP, SMTP, FTP), encodings or formats (e.g. HTML, XML), and/or protection schemes (e.g. VPN, secure HTTP, SSL).

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method of determining and identifying trips associated with transit trip patterns, comprising:
responsive to a user request, determining a plurality of trip patterns between an origin and a destination;
generating trips for each of the plurality of trip patterns, each trip corresponding to an instance of transportation;
filtering the trips;
annotating each trip in the filtered trips with transit data; and
selecting one or more trips from the annotated trips based upon the transit data associated with each respective trip, the user request, or combinations thereof.

2. The computer-implemented method of claim 1, wherein the plurality of trip patterns are determined using an iterative graph search method.

3. The computer-implemented method of claim 1, wherein filtering the trips includes utilizing a trip duration function that specifies a minimum trip duration over a time interval for the trips as a function of time.

4. The computer-implemented method of claim 3, wherein the trip duration function comprises a piecewise linear function.

5. The computer-implemented method of claim 1, wherein the transit data comprises real-time information, the method further comprising revising the duration associated with a trip based upon the transit data.

6. The computer-implemented method of claim 1, wherein the transit data comprises a sequence of transfer stations, departure time, arrival time, wheelchair accessibility, or combinations thereof.

7. The computer-implemented method of claim 1, wherein filtering the trips comprises removing one or more trips that do not provide a trip duration within a threshold of a minimum trip duration specified by a trip duration function.

8. The computer-implemented method of claim 1, wherein the trips comprise frequency based transit trips.

9. The computer-implemented method of claim 1, wherein determining a plurality of trip patterns is based on a cost model.

10. The computer-implemented method of claim 1, wherein each trip comprises a sequence between two stations having an associated departure time and arrival time.

11. A computing system for determining and identifying trips associated with transit trip patterns, the computing system comprising a processor and a memory, the system comprising:
a trip pattern identification module implemented by the processor, responsive to a user request, the trip pattern implementation module configured to determine a plurality of trip patterns between an origin and a destination;
a trip generation module implemented by the processor, the trip generation module configured to generate trips for each of the plurality of trip patterns, each trip in the trips corresponding to an instance of transportation;
a filtering module implemented by the processor, the filtering module configured to filter the trips;
an annotation module implemented by the processor, the annotation module configured to annotate each trip in the filtered trips with transit data; and
a selection module implemented by the processor, the selection module configured to select one or more trips from the annotated trips based upon the transit data associated with each respective trip, the user request, or combinations thereof.

12. The system of claim 11, wherein the transit data comprises real-time information, the method further comprising revising the duration associated with a trip based upon the transit data.

13. The system of claim 11, wherein the transit data comprises a sequence of transfer stations, departure time, arrival time, wheelchair accessibility, or combinations thereof.

14. The system of claim 11, wherein the filtering module is configured to remove one or more trips that do not provide a trip duration within a threshold of a minimum trip duration specified by to trip duration function.

15. The system of claim 11, wherein the trips comprise frequency based transit trips.

16. The system of claim 11, wherein the trip pattern identification module is utilizes a cost model.

17. A non-transitory computer-readable medium storing instructions that when executed by one or more processors cause the one or more processors to perform operations comprising:
determining a plurality of trip patterns between an origin and a destination, responsive to a user request;
generating trips for each of the plurality of trip patterns, each trip corresponding to an instance of transportation;
filtering the trips;
annotating each trip in the filtered trips with transit data; and
selecting one or more trips from the annotated trips based upon the transit data associated with each respective trip, the user input, or combinations thereof.

18. The computer-readable medium of claim 17, wherein the plurality of trip patterns are determined using a graph search method.

19. The computer-readable medium of claim 17, wherein a trip duration function specifies a minimum trip duration over a time interval for the trips as a function of time.
